(19) United States
(12) Patent Application Publication
(10) Pub. No.: US 2013/0067750 A1
(43) Pub. Date: Mar. 21, 2013

(54) ASSISTED FOLDING KNIFE WITH HANDLE HAVING POKING ELEMENT

(71) Applicant: Chih-Chen KAO, Taoyuan City (TW)

(72) Inventor: Chih-Chen KAO, Taoyuan City (TW)

(21) Appl. No.: 13/233,423

(22) Filed: Sep. 15, 2011

(51) Int. Cl. B26B 1/06

(52) U.S. Cl. 30/159

(57) ABSTRACT

The present invention is to provide an assisted folding knife, which includes a handle; a blade having a first end pivotally connected to a first end of the handle; a first resilient element having a first end positioned proximate to a second end of the handle and a second end extending to the pivotally connecting position of the handle and blade, such that when the blade has been rotated out from the handle by a predetermined angle, the first resilient element produces a torque tending to rotate the blade out of the handle; a post fixed on the blade, and exposed outside the handle when the blade is completely received in the handle; and a poking element pivotally provided in the handle and having a first end lying outside rotation of the blade, and a second end pressed against the post when the blade is completely received in the handle.

### FIELD OF THE INVENTION

The present invention relates to a folding knife, more particularly to an assisted folding knife with a handle having a poking element, wherein a blade of the assisted folding knife can be driven out by actuating the poking element, and the position at which the user is required to actuate the poking element is away from the rotation path of the blade, thus freeing the user of any worry about thumb/finger cut.

### BACKGROUND OF THE INVENTION

The conventional switchblade is highly dangerous in that the blade is driven out from the handle by the resilient restoring force of a spring. If a user puts the switchblade in a pocket of the clothes he or she is wearing, the switchblade is subject to shocks when the user walks or exercises. Should the switchblade be triggered by such shocks, the blade will pop out from the handle and may injure the user as a result.

To solve this problem, an assisted folding knife with a resilient element was developed, as shown in FIGS. 1A to 1C. The assisted folding knife 1 includes a blade 11, a handle 13, a resilient element 15, and a stopper 17. A first end of the blade 11 is pivotally connected to a first end of the handle 13, so as for the blade 11 to rotate into or out from the handle 13 about the pivotally connecting position. The blade 11 is also provided with a post 111 which is adjacent to the first end of the blade 11 and outside the handle 13. The resilient element 15 has a first end positioned proximate to a second end of the handle 13 and a second end extending to the pivotally connecting position of the handle 13 and the blade 11. When the blade 11 is completely received in the handle 13, the resilient element 15 presses against the first end of the blade 11. Consequently, the portion of the resilient element 15 that presses on the first end of the blade 11 exerts a first force A on the blade 11, as indicated by the dashed-line arrow A in FIG. 1A. The first force A causes the blade 11 to rotate into the handle 13 such that the blade 11 is securely positioned in the handle 13. However, when the blade 11 is subjected to an applied force and rotated out from the handle 13 by a predetermined angle (about 4 to 8 degrees), the resilient element 15 exerts a second force B on the blade 11, as indicated by the dashed-line arrow B in FIG. 1B. As the second force B tends to rotate the blade 11 out from the handle 13, the blade 11 is rotated instantly and completely out of the handle 13, as shown in FIG. 1C. Once the blade 11 is rotated completely out of the handle 13, the stopper 17 is pressed against the first end of the blade 11 and thereby prevents the blade 11 from rotating or folding into the handle 13.

Referring to FIGS. 1A and 1B, the assisted folding knife 1 is so configured that the resilient element 15 exerts different forces on the blade 11 when pressing against different portions thereof, and by such different forces, the blade 11 is positioned securely in the handle 13 or driven to spin rapidly out of the handle 13. Therefore, when it is desired to rotate the blade 11 out from the handle 13, the user only has to push the post 111 with a thumb and rotate the blade 11 out from the handle 13 by a predetermined angle (about 4 to 8 degrees), and the blade 11 will snap out of the handle 13 instantaneously as in the case of the conventional switchblade. Now that the user must apply a force to the post 111 in order to drive the blade 11 out from the handle 13, the blade II is unlikely to pop out due to collision that takes place when the user carrying the assisted folding knife 1 is walking or moving. After all, the assisted folding knife 1 is different from the conventional switchblade, whose blade pops out at the touch or press of a button. The blade 11 of the assisted folding knife 1 will not spin out of the handle 13 unless a pushing force is applied to the post 111 to turn the blade 11 out from the handle 13 by a predetermined angle (about 4 to 8 degrees).

While the assisted folding knife 1 described above overcomes the drawbacks of the conventional switchblade, the following problems remain to be solved:

(1) Referring to FIGS. 1A and 1B, a user wishing to use the assisted folding knife 1 must push the post 111 with a thumb in order to drive the blade 11 into rotation. However, the post 111 usually has a small height for esthetic reasons; consequently, the distance between the top end of the post 111 and the surface of the handle 13 is rather small. Because of that, the user may have problem pushing the post 111, and it can be prohibitively difficult for a first-time user to open the assisted folding knife 1 with a single hand. Thus, the convenience of use of the assisted folding knife 1 is impaired.

(2) Given the limited height of the post 111, a user trying to push the post 111 must place his or her thumb/finger close to the surface of the blade 11. Moreover, the user's thumb/finger is in the rotation path of the blade 11 when the blade 11 snaps out of the handle 13. In consideration of the above, the user has every reason to worry about the blade 11 cutting his or her thumb/finger when using the assisted folding knife 1.

(3) As the direction in which the user pushes the post 111 is not parallel to that in which the blade 11 rotates outward, resolution of the pushing force occurs, which may cause the pivotal connection between the blade 11 and the handle 13 to become loose after long-term use, thus compromising the tightness of connection between the components of the assisted folding knife 1.

According to the above, the existing assisted folding knife, though effective in solving the problems of the conventional switchblade, still leaves some room for improvement. Therefore, the issue to be addressed by the present invention is to better the existing assisted folding knife in terms of both convenience and safety of use.

### BRIEF SUMMARY OF THE INVENTION

In view of the fact that the assisted folding knife described above cannot fully satisfy user needs, the inventor of the present invention, by incorporating the spirit of constant improvement and years of practical experience into extensive research and experiment, finally succeeded in developing an assisted folding knife with a handle having a poking element, so as to provide a more convenient and safer assisted folding knife than the prior art devices.

It is an object of the present invention to provide an assisted folding knife with a handle having a poking element, wherein the blade of the assisted folding knife can be driven out by actuating the poking element, and wherein the position at which the user is required to actuate the poking element is away from the rotation path of the blade, thus freeing the user of any worry about thumb/finger cut. The assisted folding knife includes a blade, a first resilient element, and a post, in addition to the handle and the poking element. The blade has a first end pivotally connected to a first end of the handle so as for the blade to rotate into or out from the handle. The first resilient element has a first end positioned proximate to a second end of the handle and a second end extending to the pivotally connecting position of the handle and the blade. When the blade is completely received in the handle, the first resilient element produces a torque tending to rotate the blade into the handle, and when the blade has been rotated out from the handle by a predetermined angle, the first resilient element produces a torque tending to rotate the blade out of the handle. The post is fixedly provided on the blade, and when the blade is received in the handle, the post is exposed from the handle. The poking element is pivotally provided in the handle and has a first end to be poked by the user, wherein the first end extends out from the handle and lies outside the rotation range over which the blade moves when popping out from the handle. When the blade is completely received in the handle, a second end of the poking element is adjacent to or pressed against the post so that, once the first end of the poking element is poked, the second end of the poking element exerts a force on the post and thereby rotates the blade out from the handle by the predetermined angle, causing the blade to spring out of the handle automatically. Hence, the user only has to poke the first end of the poking element single-handedly, and the second end of the poking element will apply a force to the post to rotate the blade out from the handle by a predetermined angle that enables the blade to pop out of the handle automatically. In consequence, the convenience of use of the assisted folding knife is significantly enhanced.

It is another object of the present invention to provide the foregoing assisted folding knife, wherein the first end of the poking element is outside the rotation path of the blade from the handle; thus, the user's thumb/finger is away from the blade when the blade spins out from the handle. As the user can use the assisted folding knife without having to worry about thumb/finger injury, the safety of the assisted folding knife is effectively increased.

It is still another object of the present invention to provide the foregoing assisted folding knife, wherein the assisted folding knife further includes a second resilient element. The second resilient element has a first end positioned in the handle and a second end fixed at the second end of the poking element. The second end of the second resilient element can exert a force on the second end of the poking element and thereby produce a torque tending to rotate the second end of the poking element into the handle. Therefore, as soon as the user releases the poking element, the second end of the poking element automatically goes back into the handle and is prevented from exposure from the handle, so as not to compromise the esthetics of the assisted folding knife.

### BRIEF DESCRIPTION OF THE SEVERAL VIEWS OF THE DRAWINGS

The structure as well as a preferred mode of use, further objects, and advantages of the present invention will be best understood by referring to the following detailed description of some illustrative embodiments in conjunction with the accompanying drawings, in which:

FIG. 1A shows a conventional assisted folding knife in the folded state;

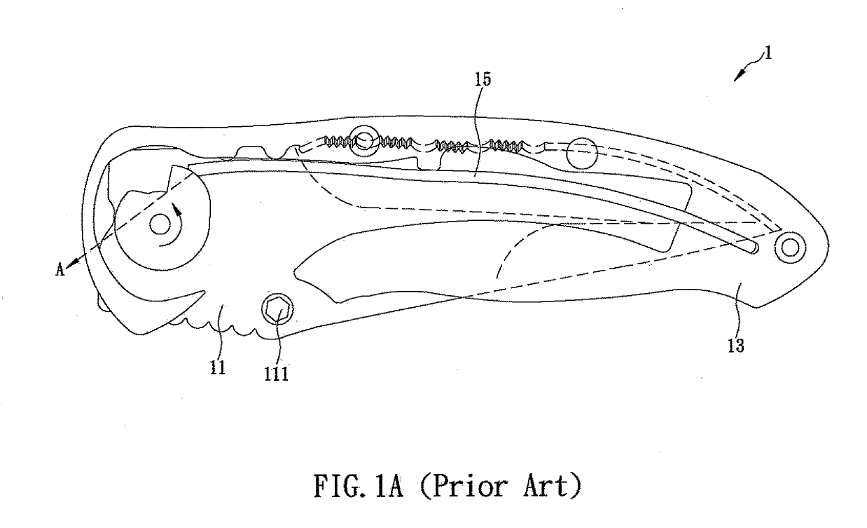

FIG. 1B shows the conventional assisted folding knife opened by a predetermined angle;

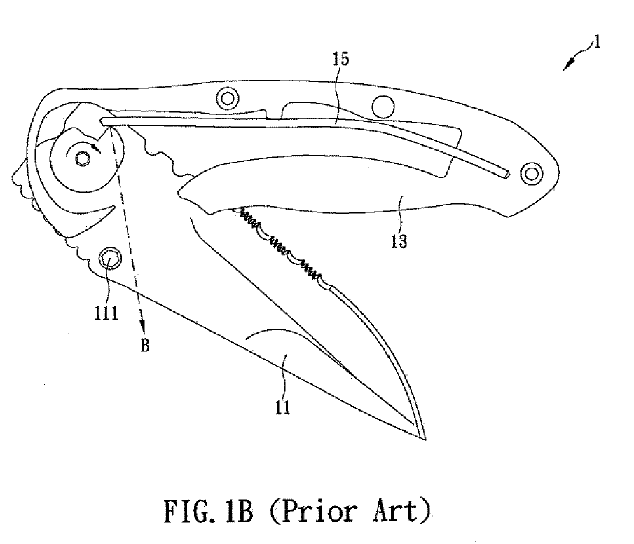

FIG. 1C shows the conventional assisted folding knife in the ready-for-use state;

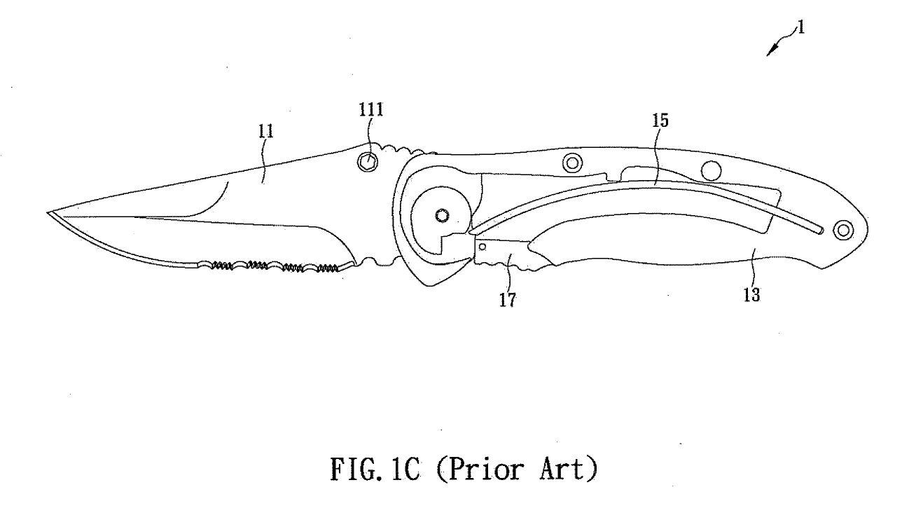

FIG. 2A shows an assisted folding knife according to a preferred embodiment of the present invention, wherein the assisted folding knife is in the folded state;

FIG. 2B is another view of the assisted folding knife depicted in FIG. 2A, wherein the assisted folding knife has been opened by a predetermined angle;

FIG. 2C is yet another view of the assisted folding knife depicted in FIG. 2A, wherein the assisted folding knife is in the ready-for-use state; and

FIG. 3 shows another preferred embodiment of the present invention.

### DETAILED DESCRIPTION OF THE INVENTION

The inventor of the present invention has long been engaged in the research and development of knives and thus found the various drawbacks and inconveniences of the conventional assisted folding knife. In consideration of this, the inventor came up with a solution as disclosed in U.S. patent application Ser. No. 12/003,248, which was filed by the present inventor on Dec. 21, 2007 and for which a patent issue notification was received by the inventor on Jul. 1, 2011. The technical means of U.S. patent application Ser. No. 12/003,248 consists in a folding knife having a poking element, wherein the poking element is pivotally coupled in a handle and disposed proximate to a pivotally connecting position of the handle and a blade. The poking element has a first end extending out from the handle so as to be poked by the user. The poking element further has a second end which is pressed against the blade when the blade is completely received in the handle. Thus, once the first end of the poking element is poked, the second end of the poking element exerts a force on the blade to turn the blade out from the handle by a predetermined angle. Meanwhile, a resilient element produces a torque tending to turn the blade out from the blade, and because of the torque, the blade pops out from the handle automatically. Therefore, the user only has to poke the first end of the poking element, and the blade will spring out from the handle automatically.

According to the above description, the second end of the poking element must be pressed against the blade in order to drive the blade, and yet it will be visually unpleasant to have the second end of the poking element jutting out of the handle. Hence, for esthetic reasons, the handle must be wide enough to cover the second end of the poking element. Such a wide handle, however, increases the production cost of the folding knife and makes the folding knife bulky, which is unfavorable in design. Therefore, by improving the technical means of U.S. patent application Ser. No. 12/003,248, the inventor designed a novel folding knife structure which is based on the same technical principle as U.S. patent application Ser. No. 12/003,248 but which satisfies both manufacturers' and consumers' needs.

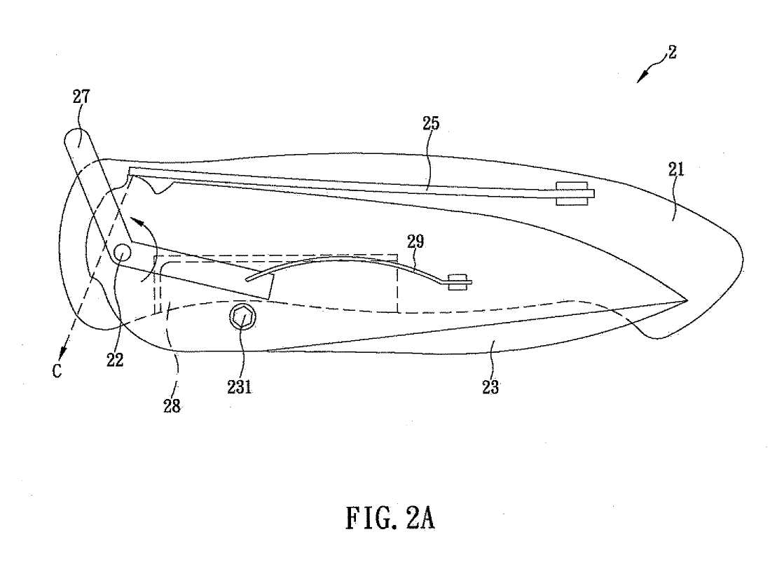

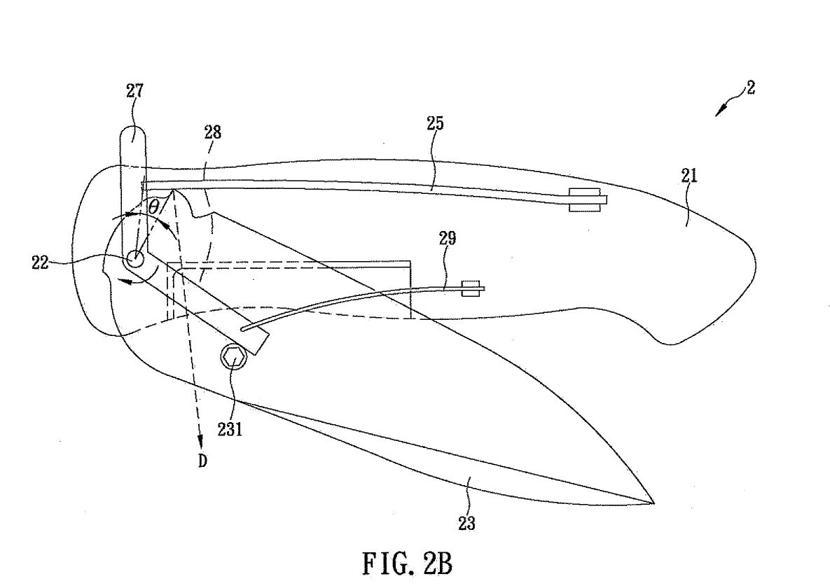

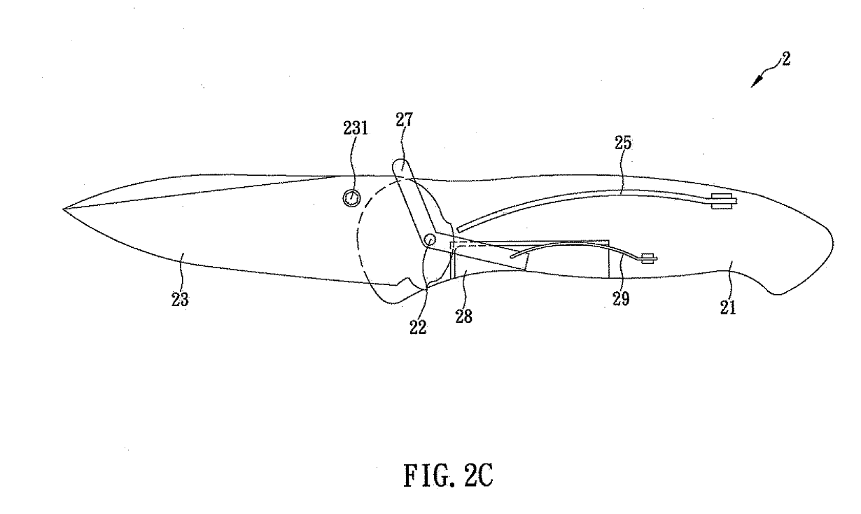

The present invention provides an assisted folding knife with a handle having a poking element. In a preferred embodiment of the present invention as shown in FIGS. 2A to 2C, the assisted folding knife 2 includes a handle 21, a blade 23, a post 231, a first resilient element 25, and a poking element 27. The blade 23 has a first end pivotally connected to a first end of the handle 21 by a pivot pin 22, so as for the blade 23 to rotate into the handle 21 (as shown in FIG. 2A) or out from the handle (as shown in FIG. 2C) about a rotation axis defined by the pivot pin 22. The post 231, which is fixedly provided on the blade 23, is exposed from the handle 21 when the blade 23 is received in the handle 21, thus allowing the user to push the post 231 and thereby rotate the blade 23 out from the handle 21.

Referring to FIGS. 2A to 2C, the first resilient element 25 is plate having a first end and a second end, wherein the first end is positioned proximate to a second end of the handle 21, and the second end extends to the pivotally connecting position of the handle 21 and the blade 23. When the blade 23 is completely received in the handle 21, the first resilient element 25 presses against and exerts a force on the blade 23 (as indicated by the dashed-line arrow C in FIG. 2A), thereby producing a torque tending to rotate the blade 23 into the handle 21. As the torque applied to the blade 23 keeps the blade 23 rotating into the handle 21, the blade 23 will stay securely received in the handle 21 in the absence of an applied force that counteracts the torque. However, once the blade 23 is subjected to such an applied force and is thus rotated out from the handle 21 by a predetermined angle θ (about 4 to 8 degrees), the position at which the first resilient element 25 presses against the blade 23 is changed. The first resilient element 25 in this state exerts a force on the blade 23 as indicated by the dashed-line arrow D in FIG. 2B, and this force produces a torque tending to rotate the blade 23 out from the handle 21. In consequence, the blade 23 pops out from the handle 21 automatically (as shown in FIG. 2C), and the assisted folding knife 2 is now ready for use.

With reference to FIGS. 2A to 2C, the post 231 is fixed to the blade 23 and stays outside the handle 21 when the blade 23 is stored in the handle 21 (as shown in FIG. 2A), thus allowing the user to push the post 231 conveniently. The poking element 27 is pivotally connected in the handle 21 and is located at the pivotally connecting position of the handle 21 and the blade 23. More particularly, the poking element 27 is of an L shape and has a first end and a second end. The first end of the poking element 27 extends out from the handle 21 and lies outside the rotation range over which the blade 23 moves when popping out from the handle 21. Therefore, a user can poke the poking element 27 with a thumb or index finger pressed against the first end of the poking element 27. On the other hand, the second end of the poking element 27 is proximate to or pressed against the post 231 when the blade 23 is completely received in the handle 21. It should be specifically pointed out that the aforesaid locations of the second end of the poking element 27 include: 1) the second end of the poking element 27 being directly pressed on the post 231; and 2) the second end of the poking element 27 being spaced from the post 231 (as shown in FIG. 2A) but movable to the post 231 when the first end of the poking element 27 is poked. Once the user pokes the first end of the poking element 27, the second end of the poking element 27 exerts a force on the post 231 to turn the blade 23 out from the handle 21 by the predetermined angle θ (as shown in FIG. 28). At the same time, the direction of the force applied by the first resilient element 25 to the blade 23 is changed (i.e., from the dashed-line arrow C in FIG. 2A to the dashed-line arrow D in FIG. 213). In consequence, the original torque that tends to rotate the blade 23 into the handle 21 is now changed to a torque tending to rotate the blade 23 out from the handle 21, and because of that, the blade 23 pops out from the handle 21 automatically and rapidly.

Referring again to FIGS. 2A to 2C, the overall structure of the assisted folding knife 2 is so designed that the user only has to poke the first end of the poking element 27 with one hand, and the second end of the poking element 27 will exert a force on the post 231. Moreover, the user only has to move the poking element 27 by a small distance and thereby rotate the blade 23 out from the handle 21 by the predetermined angle θ, and the blade 23 will automatically pop out from the handle 21 to facilitate use of the assisted folding knife 2. In order to secure the blade 23 outside the handle 21 while the assisted folding knife 2 is in use (i.e., when the blade 23 has been rotated out from the handle 21), the assisted folding knife 2 further includes a stopper 28 provided in the handle 21. When the blade 23 has been rotated completely out of the handle 21 (as shown in FIG. 2C), the stopper 28 is engaged with the first end of the blade 23 to keep the blade 23 from rotating or folding into the handle 21. Thus, the blade 23 is prevented from rotating into the handle 21 during use, and only when the stopper 28 is driven out of engagement with the blade 23 will the blade 23 become rotatable again. While the stopper 28 in the present embodiment is depicted in the drawings as a plate, the stopper 28 in a different embodiment of the present invention can take other forms as well. For example, the stopper 28 can be a bulging point, and the first end of the blade 23 can be formed with a recess corresponding in position to and engageable with the bulging point.

Furthermore, in order to prevent the poking element 27 from being exposed from the handle 21—and hence compromising the esthetics of the assisted folding knife 2—while the assisted folding knife 2 is in use, the assisted folding knife 2 further includes a second resilient element 29 as shown in FIGS. 2A to 2C. The second resilient element 29 has a first end disposed inside the handle 21 and a second end fixed at the second end of the poking element 27. The second resilient element 29 is configured to exert a force on the second end of the poking element 27 and thereby produce a torque tending to rotate the second end of the poking element 27 into the handle 21. Thus, when the poking element 27 is not pressed by the user, the second end of the poking element 27 is automatically received in the handle 21. Besides, while the second resilient element 29 in this embodiment is a plate, it is feasible to implement the second resilient element 29 as a spring or other resilient elements in another embodiment of the present invention.

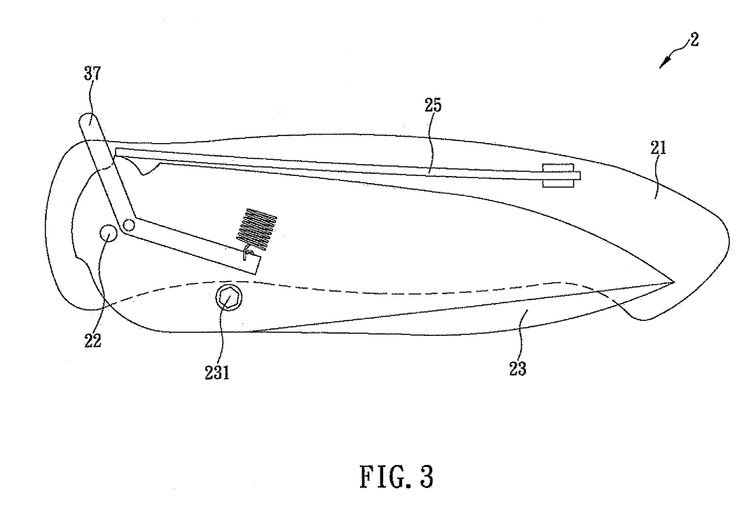

In addition, the location of the poking element may vary according to design requirements and is not limited to the pivotally connecting position of the blade and the handle. Please refer to FIG. 3 for a different preferred embodiment of the present invention, wherein all the components are designated by the same reference numerals as in the previous embodiment, except for those whose connection relationships are changed. The poking element 37 of the assisted folding knife 2 is pivotally connected in the handle 21 and disposed proximate to the pivotally connecting point of the handle 21 and the blade 23 (i.e., adjacent to the pivot pin 22). More particularly, the poking element 37 has a first end extending out from the handle 21 and a second end which is directly pressed against the post 231 when the blade 23 is completely received in the handle 21 or which can be pressed against the post 231 by rotation of the poking element 37 when the blade 23 is completely received in the handle 21. Thus, the user only has to poke the first end of the poking element 37, and the second end of the poking element 37 will exert a force on the post 231 to turn the blade 23 out from the handle 21 by the predetermined angle θ, thereby triggering the blade 23 to rotate automatically and completely out of the handle 21.

With reference to FIGS. 2A to 2C, it can be known from the above that the assisted folding knife 2 of the present invention achieves the following advantageous effects:

(1) As the poking element 27 only requires to be poked a small distance, a user poking the poking element 27 will feel as if he or she is pushing a button. Thus, the assisted folding knife 2 can simulate the feel of opening a conventional switchblade.

(2) The blade 23 will not automatically pop out of the handle 21 unless the blade 23 is rotated out from the handle 21 by the predetermined angle θ first. Since the colliding or shaking force to which the assisted folding knife 2 is generally subject when being carried around will not cause the poking element 27 to push the blade 23 by the predetermined angle θ, and the first resilient element 25 will drive the blade 23 into the handle 21 when the angle by which the blade 23 is rotated is smaller than the predetermined angle θ, the safety of use of the assisted folding knife 2 is effectively enhanced.

(3) As the first end of the poking element 27 is located outside the rotation range over which the blade 23 moves when popping out from the handle 21, the user's thumb/finger will not be close to the blade 23 when poking the poking element 27. Hence, the user can rest assured that the assisted folding knife 2 can be safely used without the risks of thumb/finger cut. Not only that, since the user can rotate the blade 23 out from the handle 21 simply by poking the poking element 27, the assisted folding knife 2 of the present invention is easy to operate even for first-time users.

(4) The force applied by the second end of the poking element 27 to the post 231 is parallel to the rotation direction of the blade 23 and therefore even after long-term use will have no effect on the overall structure of the assisted folding knife 2. In consequence, the service life of the assisted folding knife 2 is effectively extended.

While the invention herein disclosed has been described by means of specific embodiments, numerous modifications and variations could be made thereto by those skilled in the art without departing from the scope of the invention set forth in the claims.

What is claimed is:

1. An assisted folding knife with a handle having a poking element, the assisted folding knife comprising:
the handle;
a blade having an end pivotally connected to a first end of the handle by a pivot pin, so as for the blade to rotate into or out from the handle about a rotation axis defined by the pivot pin;
a first resilient element having a first end positioned proximate to a second end of the handle and a second end extending to a pivotally connecting position of the handle and the blade so that, when the blade is completely received in the handle, the first resilient element produces a torque tending to rotate the blade into the handle, thereby allowing the blade to be securely received in the handle, and when the blade is rotated out from the handle by a predetermined angle, the first resilient element produces a torque tending to rotate the blade out from the handle, thereby causing the blade to pop out from the handle automatically;
a post fixedly provided on the blade, wherein the post is exposed from the handle when the blade is received in the handle; and
the poking element pivotally connected in the handle and disposed at or proximate to the pivotally connecting position of the handle and the blade, the poking element having a first end which extends out from the handle, lies outside a rotation range over which the blade moves when popping out from the handle, and is provided for being poked, the poking element further having a second end which is proximate to or pressed against the post when the blade is completely received in the handle, so that once the first end of the poking element is poked, the second end of the poking element exerts a force on the post and thereby rotates the blade out from the handle by the predetermined angle.

2. The assisted folding knife of claim 1, further comprising a second resilient element, the second resilient element having a first end positioned in the handle and a second end positioned at the second end of the poking element so as to generate a torque tending to rotate the second end of the poking element into the handle.

3. The assisted folding knife of claim 2, further comprising a stopper provided in the handle, wherein when the blade is rotated completely out of the handle, the stopper is engaged with the end of the blade to prevent the blade from rotating or folding into the handle, and only when the stopper is driven out of engagement with the blade will the blade become rotatable again.

4. The assisted folding knife of claim 3, wherein the poking element is L-shaped.
